(19) United States
(12) Patent Application Publication
(10) Pub. No.: US 2008/0250040 A1
(43) Pub. Date: Oct. 9, 2008

(54) System and method for managing online networking information

(76) Inventors: Christos M. Cotsakos, Palm Beach Gardens, FL (US); Hannah B. Cotsakos, Palm Beach Gardens, FL (US); Suzanne R. Cotsakos, Palm Beach Gardens, FL (US); Robert Knowles, Palm Beach Gardens, FL (US); Judy Balint, Jupiter, FL (US); David R. Ewing, Jupiter, FL (US); Mircea R. Ionescu, Boynton Beach, FL (US); Charles Yi-chi Lin, Palm Beach Gardens, FL (US); Scott D. Yelich, West Palm Beach, FL (US); Keith Lee, Boynton Beach, FL (US); Jennifer B. Lowe, Palm Beach Gardens, FL (US)

Correspondence Address: THOMAS LATHRAM, 6601 KOLL CENTER PKWY, SUITE 245, PLEASANTON, CA, 94566, US

(21) Appl. No.: 12/080,700

(22) Filed: Apr. 4, 2008

Related U.S. Application Data
(60) Provisional application No. 60/922,294, filed on Apr. 6, 2007.

(51) Int. Cl. G06F 17/30

(52) U.S. Cl. 707/100; 707/E17.005

(57) ABSTRACT

A method and data structures for obtaining, distributing, managing, and utilizing information, including online content and user biographical information, in an online networking system are presented. Profile data pointers that point to profile data structures and item data pointers that point to item data structures are employed to access users' views and media content in a manner that allows for viral copying of content throughout the system yet permits the system and content owners to maintain control over the content. Users' biographical information is developed based in part on users' behavior in the networking system, and is collected and aggregated in the respective data structures to support targeted advertising based on the data, and protection of users' personally identifying information.

### BACKGROUND

The proliferation of networking websites that has occurred in recent years presents many promising opportunities but several problems have surfaced. The most virally successful websites have no reliable means of generating revenue from their success and are widely perceived as of interest only to younger users. Other websites, or just “sites,” appeal only to narrowly focused or special-interest groups. More senior, successful, higher-income producing individuals would also appreciate the ability to network freely and creatively with their family, social circles and business contacts, but they are concerned about security, control and privacy of their personally identifying information at such sites. They want to know that such sites are safe, and that their personal and private information won't be disclosed to others. Yet they appreciate the value of a personally tailored experience and the availability of information about others with whom they interact. They also want more robust tools and features than are available on the most popular sites yet they don't want, and simply won't use, sites that are difficult to use or layered with complexity. They want basic functionality for free. They may be willing to pay for increased features or functionality but they don't want to pay for features they don't want or won't use.

### BRIEF DESCRIPTION OF THE DRAWINGS

The subject matter disclosed in this specification is illustrated by way of example, and not by way of limitation, in the figures of the accompanying drawings, which are incorporated into and constitute a part of this specification, and in which like reference numerals refer to similar elements.

FIG. 1 depicts an online networking system in accordance with one embodiment of the invention. Information servers include a profile server and an item server. Client computers for an owner, and a first and second visitor, display user views and access the information servers via the Internet.

FIGS. 2A-E constitute a flow chart that depicts the steps for uploading, copying and deleting an owner's media item, and for collecting visitor biographical information and storing aggregated biographical information in respective data structures, in accordance with one embodiment of the invention.

FIG. 3 depicts an owner profile data structure and a view presented in response to a request via a profile data pointer that points to the owner profile data structure, in accordance with one embodiment of the invention.

FIG. 4 depicts an item data structure in accordance with one embodiment of the invention.

FIG. 5 depicts a calendar system in accordance with one embodiment of the invention.

### DETAILED DESCRIPTION

Networking websites can collect a wealth of user data that can be harvested, mined and either presented free to users as an enticement to subscribe or participate, or sold to users, advertisers and marketers to generate a reliable revenue stream. However, a successful online networking site produces huge amounts of data, and collecting and mining such data using traditional methods is expensive and time consuming. As a result, many sites only collect such information as profile data that is obtained at initial signup and “context” data that is collected and logged using a session cookie that logs a user's clicks during a particular session (“user Jones clicked on a picture of a car today, so he must be interested in cars”). Although somewhat valuable, such information is only the tip of the iceberg. A wealth of richer, deeper, more reliable and valuable data is available, based not only on users' biographical and context information but also on their individual and collective behavior and relationships. The challenge is to extract such information quickly, efficiently and cost-effectively.

Moreover, the very success of an online networking site may expose the owner to significant liability. An indicator of the success of such a site is the richness and variety of its content. However, once a media item such as a photograph, video clip, audio file or other creative content is uploaded to the site, the owner of the item and the owner of the site can quickly lose control of the item. If the item is popular, copies may proliferate throughout the site and beyond. If the content is pirated, there is no realistic way to remove it or prevent further infringement. A solution is needed that allows for free and viral copying of popular content and yet allows both the owner of the content and the owner of the website to maintain control of the content.

The subject matter disclosed in this specification is illustrated by way of example, and not by way of limitation, in the figures of the accompanying drawings, which are incorporated into and constitute a part of this specification, and in which like reference numerals refer to similar elements.

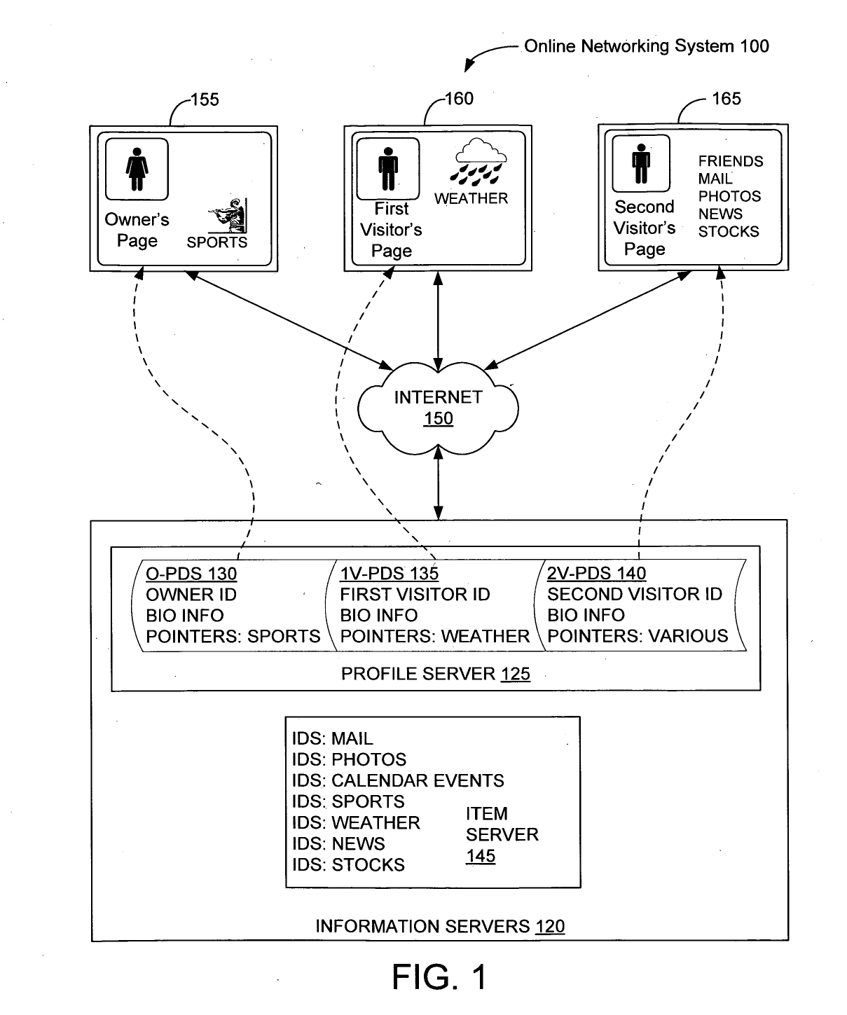

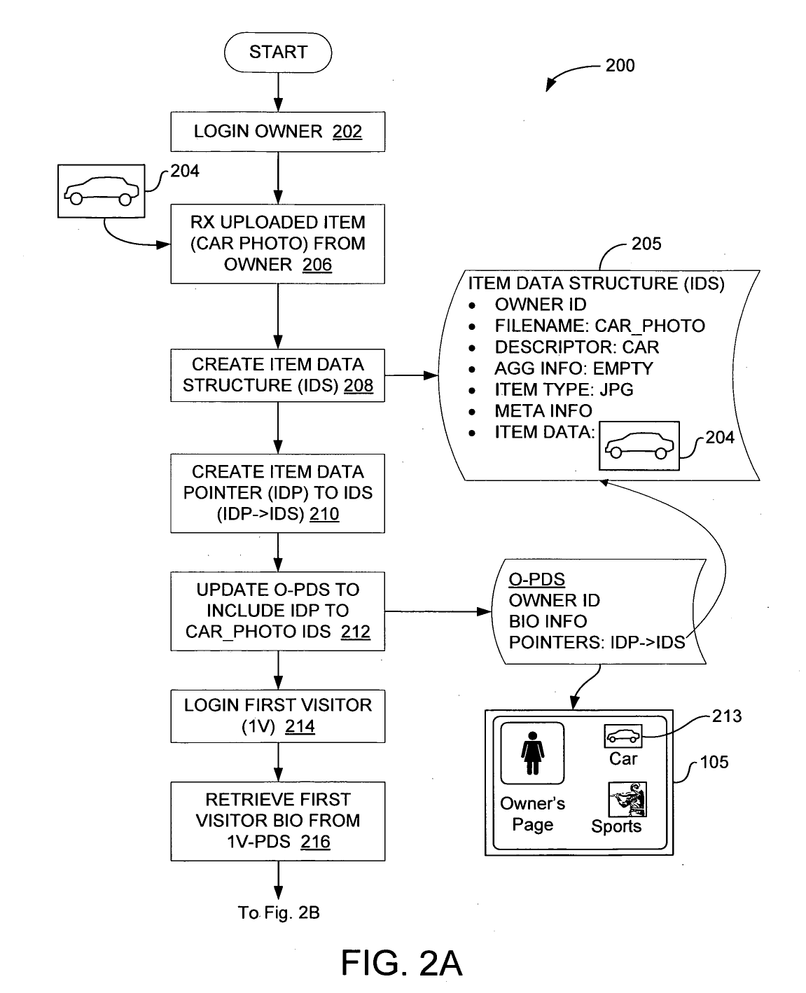

FIG. 1 depicts an online networking system in accordance with one embodiment of the invention. Information servers include a profile server and an item server. Client computers for an owner, and a first and second visitor, display user views and access the information servers via the Internet.

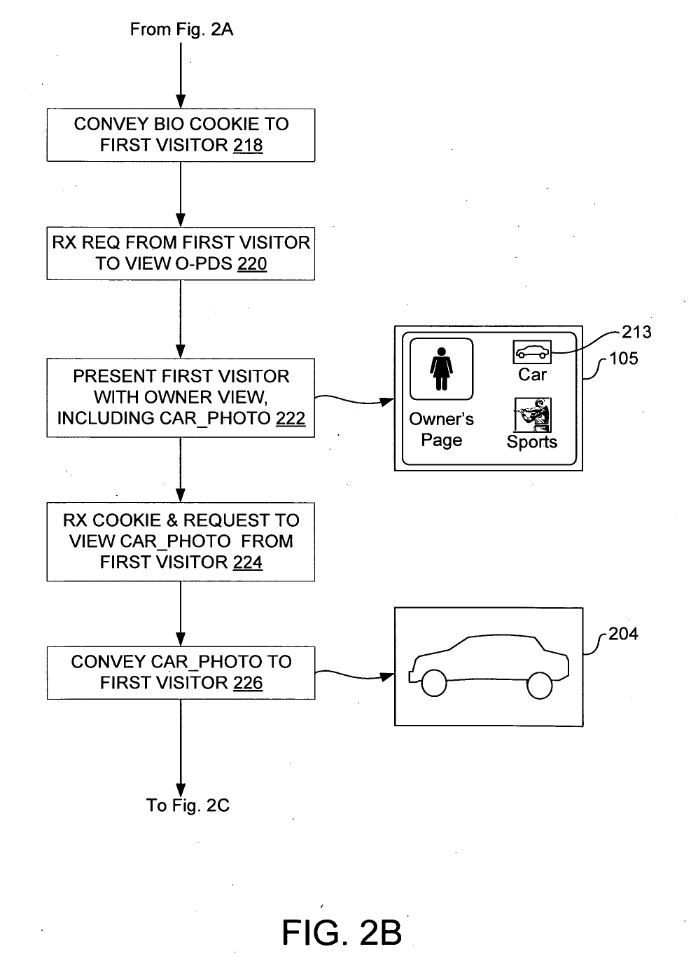

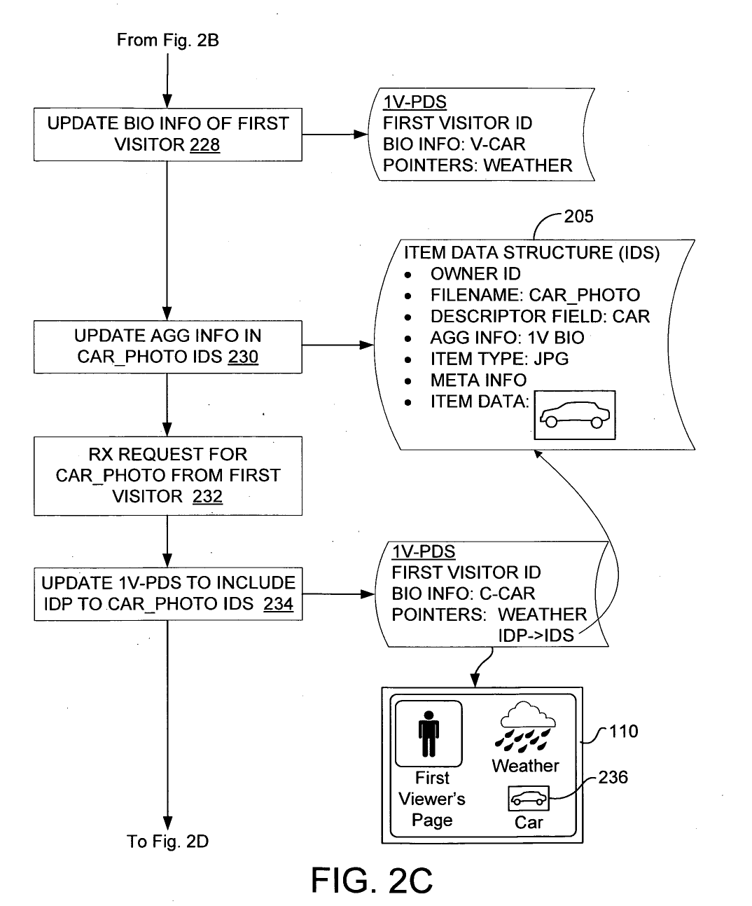

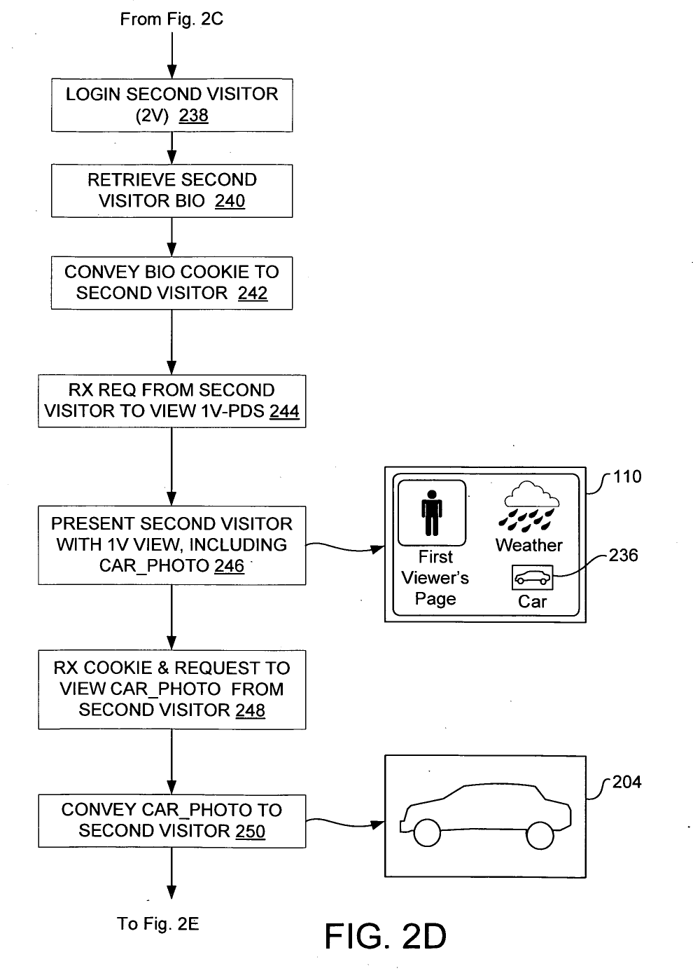

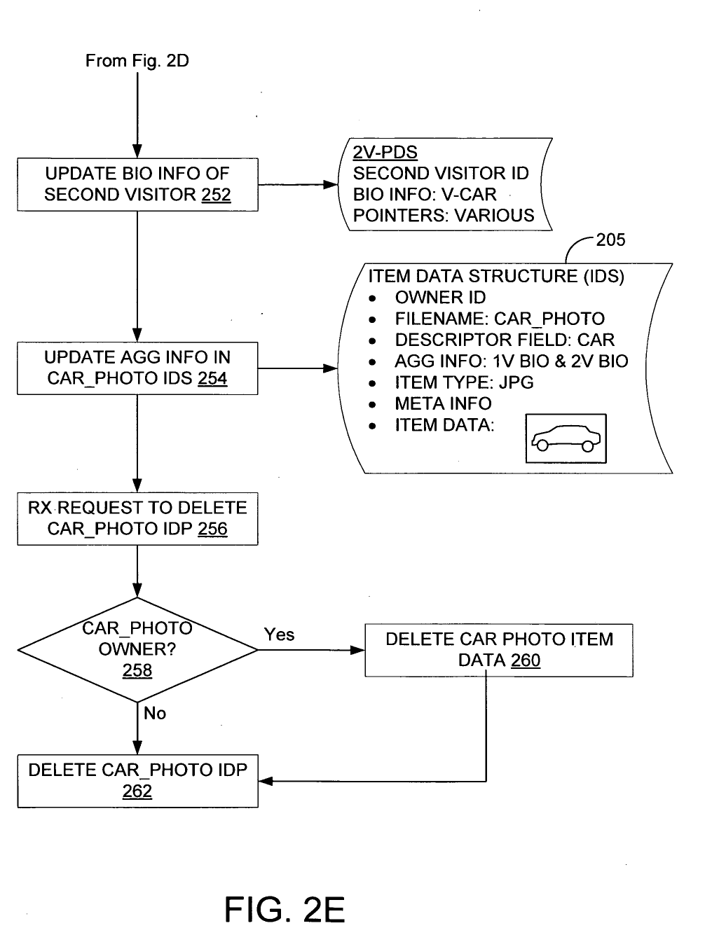

FIGS. 2A-E constitute a flow chart that depicts the steps for uploading, copying and deleting an owner's media item, and for collecting visitor biographical information and storing aggregated biographical information in respective data structures, in accordance with one embodiment of the invention.

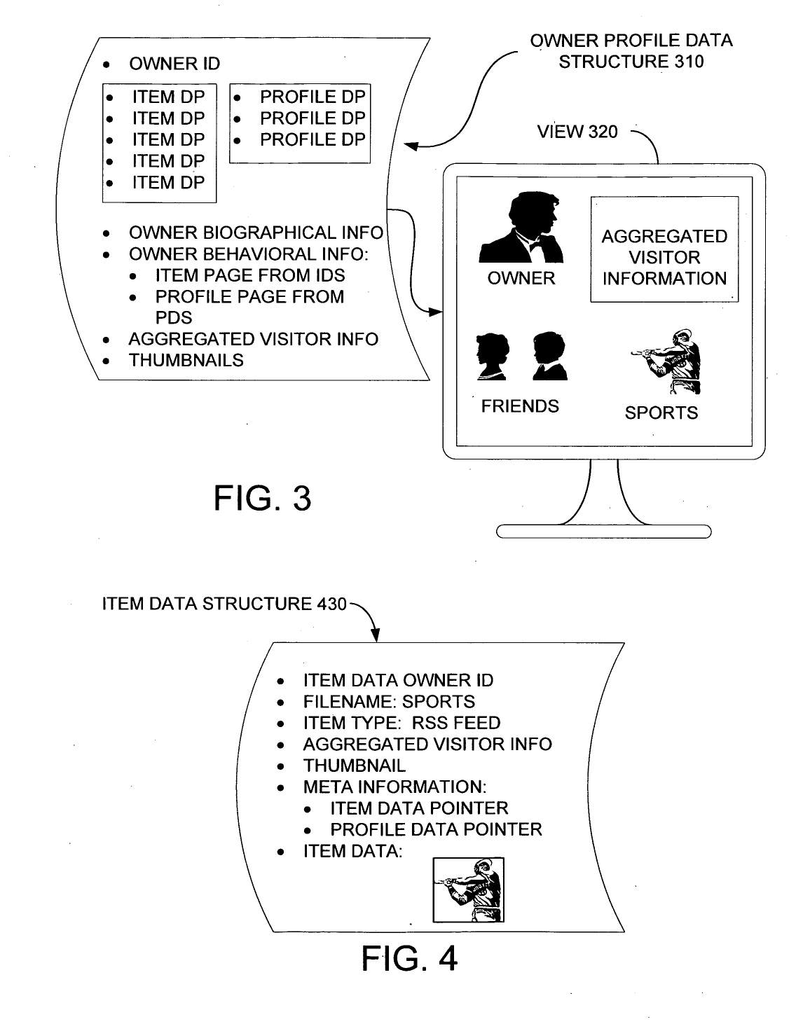

FIG. 3 depicts an owner profile data structure and a view presented in response to a request via a profile data pointer that points to the owner profile data structure, in accordance with one embodiment of the invention.

FIG. 4 depicts an item data structure in accordance with one embodiment of the invention.

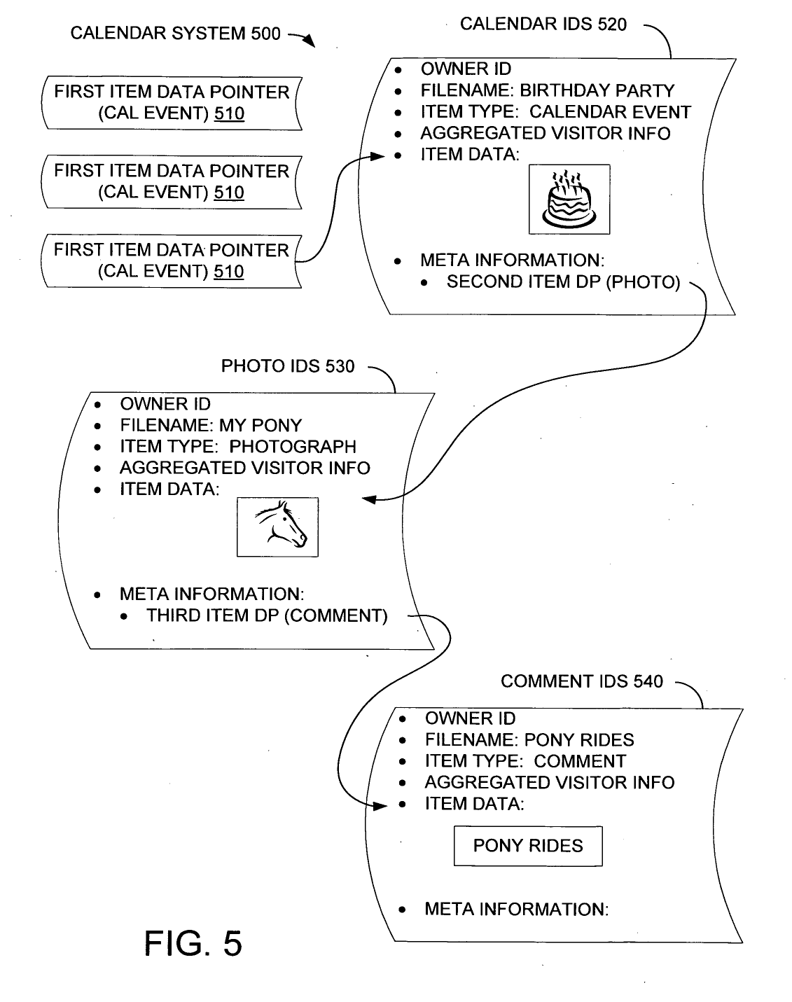

FIG. 5 depicts a calendar system in accordance with one embodiment of the invention.

The following detailed description presents a system and method for obtaining, managing, utilizing and presenting online networking content and data based on user profiles, user behavior and user relationships. Those of ordinary skill in the art will realize that this detailed description is illustrative only, and is not intended to be in any way limiting. Other embodiments will readily suggest themselves to skilled persons having the benefit of this disclosure. For purposes of clarity, not all routine features and components of the present invention are shown or described. A wide variety of implementations are possible, and the method steps, data structures and other elements may be implemented using a variety of computing platforms, operating systems, computer programs, communication, storage and processing mechanisms, and purpose-specific and programmable devices. Each implementation may entail numerous decisions about features and components in the course of development that are specific to that implementation. Such development may be difficult and time-consuming, yet it would be routine to one of ordinary skill in the art having the benefit of this disclosure.

FIG. 1 depicts an online networking system 100 in accordance with one embodiment, which includes one or more information servers 120. In the illustrated embodiment, there is an application server for computer programs and there are other components and elements of the networking system which, for clarity, are not shown, but which would be known by one of ordinary skill in the art implementing the illustrated embodiment to be necessary to the implementation. One of ordinary skill in the art would also realize that the servers of the networking system can be implemented on multiple machines or on a single machine.

The information servers 120 store a variety of information organized into discrete data structures. Information stored in the information servers 120 includes data that when organized and displayed or presented to the user in a meaningful way becomes content. Content refers to the textual, visual and aural information displayed or presented to a user that creates the experience encountered by a user of the online networking system 100.

The information servers 120 include a profile server 125 and an item server 145. The profile server 125 includes three profile data structures in accordance with one embodiment, an owner data structure O-PDS 130 and first and second visitor data structures 1V-PDS 135, and 2V-PDS 140. The owner profile data structure O-PDS 130 includes an owner ID, biographical information specific to an owner of the profile data structure, and data pointers. In the depicted embodiment, the owner's biographical information can include a wide variety of information specific to the owner, such as name, address, phone number, email address, age, education, physical attributes, income, interests, memberships, preferences in various categories, family information, social information, business information, political and religious affiliations, and any other owner information. In the depicted embodiment, the owner is a user of the online networking system who has uploaded some digitized media content, such as a photograph or video, or has created some digitized media content such as an email message or a comment, and is therefore referred to herein as the owner of the media content. Users other than the owner are often referred to herein as visitors. Media content is referred to herein as an item. There can be many forms of items in the depicted embodiment, including photos, pictures, graphics, video or audio clips, email messages, comments, bulletin postings, blog postings, calendar events and RSS feeds. The digitized data that represents the item and which, when requested, will result in display of the owned item is referred to herein as item data.

The O-PDS 130 can include profile data pointers and item data pointers. Visitors may request a view of a user's profile via a profile data pointer that points to the user's profile data structure. Visitors may request items via an item data pointer that points to an item data structure that includes the item data corresponding to the item, as explained in detail herein. In the depicted embodiment, the owner is interested in sports, and the O-PDS 130 includes an item data pointer to an item data structure containing item data for a sports item. A wide variety of information specific to the owner can be included in the owner's profile data structure. For example, in the illustrated embodiment, although not shown, the owner's profile data structure O-PDS 130 includes aggregated visitor information about other users who requested a view of the owner's profile, and information about views and items requested by and presented to the owner. In another embodiment, such information is maintained elsewhere.

The first visitor profile data structure 1V-PDS 135 in profile server 125 includes a first visitor ID that uniquely identifies a user of the networking system, biographical information specific to the first visitor, and data pointers. In the depicted embodiment, the visitor data structure 1V-PDS includes an item data pointer to an item data structure that contains item data for a weather-related RSS feed item. The second visitor profile data structure 2V-PDS 140 includes a second visitor ID that uniquely identifies another user of the networking system, biographical information specific to the second visitor, and data pointers. In the depicted embodiment, the data pointers include item data pointers that point to various item data structures, and profile data pointers that point to profile data structures of the second visitor's friends. In this example, the first and second visitors access views of other users' profile data structures and items for which representations appear in those views. Users who are particularly interested in an item may also copy that item to a view in their own profile data structure by copying the pertinent item data pointer and placing it in their profile data structure, after which time the item will be available to visitors of their profile data structure. Embodiments that facilitate sharing of items in this manner are detailed below.

The item server 145 includes item data structures. In the depicted embodiment, the item server 145 includes data structures for various items such as e-mail messages, photos, comments and calendar events, among others. Item data structures are described in greater detail elsewhere herein. In the illustrated embodiment, a profile data structure includes only one user identifier or ID and includes only information specific to or associated with that user, and an item data structure includes only one user identifier or ID that identifies the owner of the item and includes only information specific to or associated with the item. Other embodiments may employ other combinations of IDs and information in the data structures. One of ordinary skill in the art will realize that a variety of data structures may be employed to store and relate the data and information included in the profile data structures and the item data structures referenced herein.

FIG. 1 shows that users' client computers 155, 160 and 165 communicate with the online networking system's information servers 120 through the Internet 150. In other embodiments, client-server communication could occur over other public or private networks such as a university's network, a company's intranet, or a wireless local area network (LAN), instead of or in addition to the Internet. Although FIG. 1 shows the owner using client computer 155 to communicate with the information servers 120, in other embodiments, other devices might be used, such as a cell phone, wireless personal digital assistant (PDA), or other devices. In FIG. 1, the owner's client computer 155 is displaying a view of the owner's profile. In the depicted embodiment, the owner has requested access to the data structure O-PDS 130 in profile server 125 via an owner profile data pointer that points to O-PDS 130. The view of the O-PDS 130 is displayed on the owner's client computer 155 in response to the request, as indicated by the dotted arrow from the O-PDS 130 to the owner's client computer 155. The owner is interested in sports, and the view on the owner's client computer shows an iconic representation of a sports item. The sports item can be displayed by clicking on the icon, which activates an item data pointer in the O-PDS 130 that points to an item data structure in the item server 145 that includes the item data for the sports item. Another user interested in sports could request a view of the owner's O-PDS 130 via the appropriate profile data pointer and display the sports item via the appropriate item data pointer.

FIG. 1 shows that the first visitor's client computer 160 is displaying a view of the first visitor's profile data structure 1V-PDS 135. The view of the first visitor's 1V-PDS 135 includes an iconic representation of a weather RSS feed item. The weather item can be displayed by clicking on the weather icon and activating an item data pointer in the 1V-PDS 135 that points to an item data structure in the item server 120 that includes the item data for the weather RSS feed item. The second visitor's client computer 165 is displaying a view of the second visitor's profile data structure 2V-PDS 140. The second visitor has multiple interests, and the view of the 2V-PDS 140 includes representations of various items. Items may be accessed by clicking on the pertinent representation in the view of the 2V-PDS 140 and activating an item data pointer in the 2V-PDS 140 that points to the pertinent item data structure in the item server 120.

The view of the 2V-PDS 140 displayed on the second visitor's client computer 165 may contain thumbnails or other iconic representations of the second visitor's friends. A view of the profile data structure for one of the second visitor's friends can be displayed by clicking on the representation of the friend and activating a profile data pointer in the 2V-PDS 140 that points to the profile data structure for the friend in the profile server 125. In the illustrated embodiment, a variety of views of the 2V-PDS are possible. For example, the view of the 2V-PDS may be a social view. In this case, the profile data pointers in the 2V-PDS might point to the second visitor's social friends. Alternatively, the view might be a business view, and the profile data pointers might point to profile data structures of the second visitor's business contacts, or the view might be a family view, and the profile data pointers might point to the profile data structures of members of the second visitor's family. For ease of reference, if a visitor's profile data structure such as the 2V-PDS includes profile data pointers to other profile data structures, the other users associated with those other profile data structures are referred to herein as the visitor's friends. This convention is used throughout. The term “friend” is used broadly herein.

As described above, users of the online networking system can display the profiles of their friends and other users who are of interest to them, and can display items of interest to them, through the use of data pointers and data structures as illustrated in FIG. 1. Thus, FIG. 1 depicts an overview of the online networking system in accordance with one embodiment. Users can also easily copy items they have accessed that are of special interest to them, and can place those items in their own profiles, as explained in detail below. In accordance with the illustrated embodiment, as users visit profiles of other users and request display of or copy items, they may leave behind biographical information about themselves. This biographical information may then be included in the data structure of the profile or item accessed and aggregated with the biographical information of other users who have accessed the same profile or item. Over time, the accumulation of the aggregated visitor information builds an increasingly detailed and accurate history of the type of user who is interested in the item. The visitor's biographical information in the visitor's own profile data structure may also be updated to include information about the items that were of interest to the visitor, so that the visitor's biographical information also becomes richer and more detailed over time. The way in which these steps are accomplished is explained below in the detailed description of FIGS. 2A-E.

FIGS. 2A-2E are a flowchart 200 showing steps and the outputs of steps of processes in accordance with some embodiments. Referring first to FIG. 2A, an owner is logged into an online networking system (Step 202) that may be of the type detailed above in connection with FIG. 1. In the depicted embodiment, the owner wants to display a car photograph 204 in an owner view available to other users. The system therefore receives, at the direction of the owner, uploaded item data that defines or represents a car photo 204 (Step 206). The system then creates an item data structure IDS 205 associated with car photo 204. In this example, this association is created by including the item data that defines the car photo 204 in the car-photo IDS 205 (Step 208). In addition to the item data, the IDS 205 includes an owner ID that identifies the owner as the owner of the item data representing car photo 204, the filename of car photo 204 (car_photo), and information as to the type of item data. In the depicted embodiment, the item data is a JPEG file.

The car-photo IDS 205 may include meta information specific to the item data. In the depicted embodiment, the meta information includes information that indicates that the photo 204 is of a car. In other embodiments, the meta information may include a wide variety of information specific to the item data. For example, the meta information may include item data pointers to other item data structures, such as an item data structure containing item data representing a comment about the car photo, or a photo of a similar car of a different color. In another embodiment in which the item data represents an email message, the meta information may contain information specific to the email message, such as the sender or other information about the message. In some embodiments the item data structure consists essentially of the item data and the item-specific information. Inessential information does not relate to the item per se, and might include e.g. error correction bits associated with the item, the item data structure, or the contents of the item data structure.

Next, at Step 210, the system creates an item data pointer (IDP) to the car-photo IDS. The system then updates the owner's profile data structure O-PDS to include the car-photo IDP pointing to the car-photo IDS (Step 212). As a result, the owner's profile data structure O-PDS includes the car-photo pointer IDP and the owner's page 105, or view, includes an icon 213 that allows visitors to select the car-photo pointer IDP to access car photo 204. In this example, the icon 213 is a thumbnail of car photo 204, but other suitable links might also be used. Visitors accessing the owner's O-PDS are now presented with a new view that includes a link to car photo 204. One of ordinary skill in the art will recognize that there are other ways that the IDP may be associated with the O-PDS. In the depicted embodiment, the IDP points to the IDS 205 that is the output of Step 208. The output of Step 212 also shows a view of the updated O-PDS. View 105 is the same as the view shown in FIG. 1, except that the view has been updated to show the thumbnail 213 representing the car photo item. The car photo is now accessible to other users via the IDP by clicking on the thumbnail. The owner can employ similar steps to further present a customized view for presentation to others. Other users of the network system can likewise present customized views.

Returning to FIG. 2A, at Step 214, the system receives a request from the first visitor to login to the system. In response, the system retrieves biographical information from the first visitor's profile data structure 1V-PDS (Step 216). One of ordinary skill in the art will realize that in other embodiments, the first visitor's biographical information may be retrieved, in whole or in part, from another location. It will further be clear that the steps of flowchart 200 need not be accomplished in the exemplary order. For example, the first visitor can be logged onto the system before the owner creates item data structure 205.

FIG. 2B continues the sequence from FIG. 2A. After collecting the first visitor's biographical information, the system conveys a cookie to the first visitor's browser (Step 218), the cookie containing some or all of the retrieved biographical information or some form of association with the first user's biographical information. A cookie is a parcel of text that may be sent by the system to the first visitor's web browser at login and later sent back by the browser each time it accesses the system during that login session. In the depicted embodiment, a new cookie is prepared and conveyed each time the first visitor logs in. The contents of the cookie can vary from time to time. For example, the categories of biographical information contained in the cookie might be specified by a particular vendor or advertiser who is willing to pay for the specified information. Interestingly, if a visitor visits the site without logging in but has received a cookie in a previous logged-in session, the system may still retrieve biological information from the previous cookie. One of ordinary skill in the art will readily realize that in other embodiments, there are other ways that biographical information may be conveyed to a user and sent back to the system as the user moves around the network.

At Step 220, the system receives a request from the first visitor for a view of the owner's profile data structure O-PDS. Such a request may be made, for example, by selecting a link that includes a profile-data pointer (PDP) to the owner's profile data structure. In one embodiment, a profile data pointer and an item data pointer are each encrypted pathways to data locations. In the depicted embodiment, a data pointer contains an encrypted pathway and additional information such as whether the data pointer is a profile data pointer or an item data pointer. The pointer also includes an encrypted timestamp. In other embodiments, a data pointer may contain different or additional information. In the depicted embodiment, a profile data pointer may be included in a profile data structure (for example, it may point to a friend's profile data structure), in the meta information in an item data structure (for example, in the car-photo IDS from Step 208 FIG. 2A, it may be in the meta information and may point to the profile data structure of a user who likes cars), or elsewhere in the system.

At Step 222, the first visitor is presented with a view of the O-PDS that includes a thumbnail representing the IDP that points to the car-photo IDS of FIG. 2A. The output of Step 222 shows that the view 105 of the O-PDS displayed to the first visitor includes the car photo thumbnail 213. At Step 224 the first visitor expresses an interest in the depicted car by activating the pointer associated with thumbnail 213, in which case the system receives the first visitor's cookie and a request to view the car photo (Step 224). As noted above, the first visitor's cookie may contain some biographical information relating to the first visitor. Responsive to the visitor's request, the system conveys car photo 204 to the first visitor for display (Step 226). Referring to FIG. 2C, also responsive to the visitor's request the biographical information in the first visitor's profile data structure 1V-PDS is updated to by the addition of V-CAR to indicate that the first visitor indicated an interest in viewing car photo 204 (Step 228). The first visitor's profile now has a record of the first visitor's interest in viewing a specific type of content, e.g. car photos, which allows the system to begin tailoring the first visitor's experience based upon the first visitor's browsing behavior.

Next, and still responsive to the visitor's request to view car photo 204, the biographical information with the first visitor's cookie is used to update the aggregated visitor information (AGG INFO) in the car-photo item data structure IDS (Step 230). The output of Step 230 shows that the AGG INFO has been updated with the first visitor's biographical information (1V BIO). The owner of the car-photo IDS now has a record associated with the IDS, and consequently with the car photo, of the attributes of a visitor who expressed sufficient interest in the car photo to interact with link 213. The cookie might identify e.g. the age, sex, income bracket, and home town of the first visitor. In collecting this sort of data from each visitor who requests a view of car photo 204, the item owner can create a valuable body of aggregated demographic information that relates to the item. The more visitors interact with items in this way, the more is learned about the items and about the visitors who interact with them. It then becomes increasingly easy to match items to users of the type who commonly find the item of interest. This of course is of great value both to users and advertisers.

The item data structure need not include a descriptor, e.g. when the data item is an unidentified photograph. In such instances the item data structure can collect visitor information to develop an ever clearer characterization of the item. If, for example, pointers to an unidentified photograph are copied mainly to sports-related profiles, then the item data is most likely related to sports. If the visitors interacting with the copied link are then mainly soccer fans, then the photograph may be presumed to relate to soccer. The more visitor biographical information is collected, the more detailed the characterization of the item in the item data structure becomes. Owners can thus leverage viewer activity to locate unidentified items or to search for items or pages responsive to a request but that lack a descriptor or do not include the particular search terms used. Owners can also sort published items, and unidentified items can contribute to a growing body of aggregated demographic information.

In the depicted embodiment, the first visitor likes the car photo and decides that he would like to be able to display a copy of the car photo on a view of his profile data structure 1V-PDS. At Step 232, the system receives a request for a copy of the car photo from the first visitor. In response, the first visitor's profile data structure is updated to include an item data pointer IPD to the car photo item data structure IDS (Step 234). The output of Step 234 shows that the 1V-PDS has been updated so that the biographical information now includes information C-CAR indicating that the first visitor requested a copy of the car photo, and that the item data pointer IDP that points to the car photo IDS is now included in the item data pointers in the first visitor's profile data structure 1V-PDS. The view 110 associated with the 1V-PDS shows that the view of the first visitor's profile data structure 1V-PDS has been updated to include a thumbnail 236 representing the car photo item data accessible via the new car photo item data pointer in the 1V-PDS.

In the depicted embodiment, a visitor has a “grab bag” associated with the visitor's profile data structure. A grab bag is temporary storage for data pointers that the visitor has copied but has not yet placed in the visitor's profile data structure. The visitor can place a data pointer in the visitor's profile data structure in a manner that allows the representation of the item to appear in the visitor's preferred location in a view of the visitor's profile data structure. In one embodiment, the request for a copy of the car photo is implemented by receiving a request from the first visitor to grab the car photo and place it in the first visitor's grab bag, followed by a request to move the car photo from the first visitor's grab bag and place it in a view of the first visitor's profile data structure. These requests result in a series of operations similar to the cut-and-paste operations in Microsoft applications, in which information is copied and placed in a clipboard and then pasted from the clipboard to a new location. In the referenced embodiment, and in response to the request to grab the car photo, the car photo IDP is copied and placed in a clipboard-like grab bag. The car photo IDP can then be copied from the first visitor's grab bag into the first visitor's profile data structure 1V-PDS. Of interest, the car photo item data in the item data structure is not copied; instead, a new item data pointer to the item data structure is included in the first visitor's profile data structure. This allows the owner of the car photo to maintain control of the distribution of the car photo and to extract useful biographical information from requests to view the car photo that come from pointers in profile data structures other than the owner's profile data structure O-PDS. In the depicted embodiment, the size of a thumbnail or other icon that activates the new pointer and its location in the layout of the view can be determined by the first visitor. The owner may also have the ability to restrict or disallow copying of pointers to item data.

The car-copying example described above can also apply to other item types. For example, a calendar event item can be grabbed from a calendar in an owner's view and copied to a visitor's calendar, or perhaps could be copied and included in an email that invites visitors to attend a calendar event. A visitor interested in the event could copy the calendar event from the email using the described operations and include it in the visitor's calendar.

FIG. 2D depicts the login of a second visitor at Step 238 of the illustrated embodiment. The second visitor's biographical information is retrieved (Step 240) and a cookie containing the second visitor's biographical information is conveyed to the second visitor's browser (Step 242). Then, assuming the second visitor elects to view the first visitor's view, the system receives a request from the second visitor for a view of the 1V-PDS (Step 244). In response, the system presents the second visitor with the first visitors page 110, as updated in Step 234 of FIG. 2C to include the thumbnail 236 associated with a pointer to the car photo IDS (Step 246). Should the second visitor request the car photo by selecting thumbnail 236, the system will receive the second visitor's cookie and a request to view the car photo (Step 248).

Responsive to the request from the second visitor to view the car photo, the system conveys the car photo to the browser of the second visitor (Step 250), updates the biographical information in the second visitor's profile data structure 2V-PDS to evince an interest in viewing cars (Step 252), and updates the car photo item data structure IDS to include some or all of the biographical information stored in the second visitor's cookie (Step 254) or elsewhere in the system. The aggregated information in the car photo item data structure IDS thus now includes biographic information pertaining to the first and second visitor, each of which expressed some interest in the car photo. Further requests for the car photo may develop the aggregated information associated with the car photo into a valuable set of demographic information. The resulting aggregated information can then be used e.g. to target the car photo to other potential viewers who might find the car photo of interest. If, for example, a viewer searching for cars is demographically similar to those identified as interested in the car photo, the system might present the car photo to the viewer, or may present an advertisement for a car of the type depicted in the car photo.

In the example of FIGS. 2A-2E, both the owner of the car photo and the first visitor include a car photo item data pointer IDP in their respective profile data structure PDS that points to the car photo item data structure IDS. Either party may wish to delete the car photo from their respective view. At Step 256 of FIG. 2E, a request to delete the car photo is received. At Step 258, the system checks to see whether the user who requested deletion of the car photo is the owner of the car photo item data as identified by the owner ID in the car photo item data structure IDS. If the user requesting deletion of the car photo is not the car photo item data owner, then only the item data pointer IDP that points to the car photo item data structure IDS is deleted (Step 262). The item data is not deleted, and the car photo can still be displayed in response to requests for the item data in the item data structure IDS made via other item data pointers IDP. If the user making the delete request is the owner of the car photo item data, as identified by the owner ID in the car photo item data structure IDS, then both the item data pointer IDP (Step 262) and the car photo item data (Step 260) are deleted. Although other car photo item data pointers may not be deleted, they can no longer be used to display the car photo because the car photo item data in the item data structure IDS to which they point has been deleted. In another embodiment, if the user who requests deletion of the car photo is the owner of the car photo item data in the item data structure IDS, the IDS is deleted. The system may maintain records of visitors who copy or delete pointers to specific items or types of items.

FIG. 3 depicts an owner profile data structure 310 in accordance with the illustrated embodiment. The owner profile data structure 310 (referred to in this section as the O-PDS 310) includes an owner ID that identifies the owner as a user who owns a media item such as a photograph, a video, or an RSS feed. As described elsewhere herein, there can be many varieties of item types. The O-PDS 310 also includes information specific to the owner, including information to present the view depicted by view 320. A view displays content represented by information included in item data structures accessed by item data pointers and in profile data structures accessed by profile data pointers. The O-PDS 310 includes a plurality of item data pointers, referred to in this section as “item DPs,” and profile data pointers, referred to in this section as “profile DPs.”

Each item DP points to an item data structure IDS that includes item data that, when requested via the respective item DP, presents the item to the requesting user. In the depicted embodiment, at least one of the item DPs in the O-PDS 310 points to an item data structure such as the item data structure 430 (referred to in this section as IDS 430) in FIG. 4 that includes item data representing a sports RSS feed item owned by the owner. Each profile DP in the O-PDS points to a profile data structure of another user such as the friends of the owner. The term “friend” is used broadly herein. It could refer to social friends or acquaintances, family members, business associates or other users with whom the owner has a relationship.

The O-PDS 310 also includes thumbnails, which are representations, often reduced in size, of an item or a user's view, in the form of a photograph, picture, drawing, avatar, video screenshot, or other representation. In the depicted embodiment, a visitor who requested the O-PDS 310 by activating the pertinent profile data pointer that points to the O-PDS 310, is presented view 320, which includes a thumbnail of the owner, thumbnails of two visitors who are the owner's friends, and a thumbnail of a sports RSS feed. The visitor could access one of the owner's friend's views by clicking on the friend's thumbnail, which would activate the profile data pointer that points to the friend's profile data structure. The visitor could access the sports RSS feed by clicking on the thumbnail for the sports RSS feed item, which would activate the item data pointer that points to the sports RSS feed item data structure (IDS 430).

The O-PDS 310 also includes owner biographical information such as name, address, phone number, email address, age, education, physical attributes, income, memberships, interests, preferences in various categories, family information, social information, business information, political and religious affiliations, and any other owner information. Owner biographical information may be obtained when the owner first participates in or becomes a member of the online networking system, or may be added later. Over time, the owner biographical information may become more detailed and thus more valuable. In the illustrated embodiment, the cookie that is delivered to the owner when the owner logs in to the system includes biographical information that was obtained from or derived from the biographical information in the O-PDS 310.

The O-PDS 310 also includes owner behavioral information such as information about views and items requested by and presented to the owner as the owner navigates around the networking system. In the depicted embodiment, owner behavioral information includes an index of the information from a page presented to the owner when the owner requests a view or an item via the appropriate data pointer. Although in the depicted embodiment, owner behavioral information is stored separately in the O-PDS 310, in another embodiment it may be included in the owner biographical information. Useful information about the owner may be obtained from evaluation or analysis of the owner behavioral information that may not be available from other sources. As the saying goes, “what you do is more important than what you say.” The owner behavioral information may allow extraction of information about tendencies, interests and preferences of which even the owner may not be consciously aware. In the illustrated embodiment, the cookie that is delivered to the owner when the owner logs in to the system may include information that was obtained from or derived from the owner behavioral information in the O-PDS 310.

The O-PDS includes aggregated visitor information. In the depicted embodiment, this is information obtained from the browsers of visitors who requested view 320 via a profile data pointer that points to the O-PDS 310. Over time, the aggregated visitor information will grow and become more detailed, thus painting a more complete picture of the characteristics of visitors who are interested in the owner's view 320. Such information could be valuable, for example, if the owner's view 320 was a business view and the owner wanted to develop information about the type of customers who visited the view 320. Such information might be used to devise a more effective advertising strategy. In the illustrated embodiment, aggregated visitor information in the O-PDS 310 is presented in a window display in view 320. Such information may be displayed in real time or periodically updated. One of ordinary skill in the art will readily recognize that there are other ways to deliver the information.

In other embodiments, some of the information depicted in the O-PDS 310 may not be collected or stored in a profile data structure, and other information not depicted may be stored collected and stored instead.

FIG. 4 shows an item data structure 430 (referred to herein as IDS 430). The IDS 430 includes an item data owner ID that identifies the owner as an owner of the item data in the IDS 430. The IDS 430 also includes a filename “sports” for the item data, and contains information that identifies the type of item data stored in the IDS 430 as an RSS feed. The IDS 430 includes aggregated visitor information about visitors who requested the item data via an item data pointer that points to the IDS 430. In the illustrated embodiment, the visitor information is collected from a cookie returned by the visitor's browser, and includes biographical and perhaps behavioral information about the visitor that was obtained from the visitor's profile data structure when the visitor logged in and received a cookie. In other embodiments, the aggregated biographical information may be obtained in other ways from one or more other sources.

In the illustrated embodiment, the aggregated visitor information is updated for each visitor who requests display of the sports RSS feed item data via an appropriate item data pointer. The result of these operations is that the IDS 430 includes updated aggregated biographical information about the visitors who requested display of the item data. This information can readily be made available to the owner of the item data, who is easily identified by the owner ID in the item data structure. In the illustrated embodiment, the information is made available to the item data owner in the form of a report. The information can also be made available to interested third parties. In other embodiments, the information can be made available or utilized in a number of different ways. Thus, it is not necessary to make the somewhat unreliable assumption that because a visitor clicked on a thumbnail of a sports RSS feed item, the visitor must be interested in sports. Instead, much more detailed and reliable biographical information about the visitors who requested display of the item is available. This information can be provided quickly, efficiently and cost effectively, without the expense of the time-consuming and extensive data mining that would otherwise be required to extract such data from a log, database or other collection of data. Such information has value and can be provided free as an incentive or can be used to produce a revenue stream. One of ordinary skill in the art will realize that such information can be made available or utilized in a number of different ways in other embodiments.

The aggregated visitor information in the IDS 430 can be disclosed without disclosing private, personally identifying user information, thus allaying concerns users might have about disclosure of their personal and behavioral information. In the illustrated embodiment, however, personally targeted ads can be delivered at the request of a third party such as a marketer based on criteria derived from the aggregated visitor information without disclosing personally-identifying information to the third party. Such advertising is effective because it is based on reliable biographical and behavioral information, and also helps to make the user's experience a more personal one. Such ads have value and can be used to produce a revenue stream.

FIG. 5 shows a calendar system 500 in accordance with the illustrated embodiment. The calendar system 500 includes three first item data pointers (cal event) 510, each of which points to calendar event item data structure calendar IDS 520, and each of which identifies the type of item data contained in the calendar IDS 520 as item data of the calendar event type. Calendar IDS 520 includes an owner ID that identifies an owner of the calendar event item data, and includes a filename “birthday party” for the item data. The calendar IDS 520 includes information that identifies the type of item data stored in the calendar IDS 520 as item data of the calendar event type. In the depicted embodiment, the item data is requested by a visitor via the third of the three first item data pointers (cal event) 510, as shown by the curved arrow from the first item data pointer (cal event) 510 to the item data in the calendar IDS 520. In the illustrated embodiment, the request is made by clicking on a birthday cake thumbnail in a calendar included in a view. The calendar may include a plurality of thumbnails that represent links to other calendar event items. In response to the request, the visitor is presented with the birthday party calendar event item, which may contain information such as the name of the person celebrating the birthday, the time, date and location of the party and other information pertinent to the birthday party. One of ordinary skill in the art will readily recognize that there are other ways to activate a first item data pointer (cal event) 510 and present the item data to the visitor.

In the depicted embodiment, the calendar IDS 520 includes meta information. A great variety of information and information types may be included in the meta information in an item data structure so long as the meta information is specific to the item data in the item data structure. In the illustrated embodiment, the meta information in the calendar IDS 520 includes a second item DP (Photo) that is an item data pointer that points to the photo IDS 530, an item data structure for a photograph of a pony. The photo IDS 530 includes an owner ID and a filename “my pony” for the pony photograph item data. The photo IDS 530 also includes information that identifies the type of item data in the photo IDS 530 as item data of the photograph type. The photo IDS 530 includes item data which represents a photograph of a pony. In the depicted embodiment, the calendar event item presented to the visitor includes a thumbnail of a pony, and the visitor requests the pony item by clicking on the thumbnail, which activates the second item DP (photo) in the calendar IDS 520. The visitor's request for the pony item is shown by the curved arrow from the second item PD (photo) in the calendar IDS 520 to the item data in the photo IDS 530. In response to the request, the visitor is presented with a photograph of a pony.

In the illustrated embodiment, the photo IDS 530 includes meta information that includes a third item DP comment, which is an item data pointer that points to comment IDS 540, an item data structure for item data of the comment type. The comment IDS 540 includes an owner ID that identifies an owner of the comment item, and a filename “pony rides” for the item data. The comment IDS 540 also includes information that identifies the type of item data in the comment IDS 540 as item data of the comment type. The comment IDS 540 includes item data that represents a comment. In the depicted embodiment, the response to the visitor's request for the pony photograph included presentation of an iconic representation of a “pony rides” comment, and the visitor requests the comment by clicking on the icon, which activates the third item DP (comment) in the meta information of the photo IDS 530. The request is shown by the curved arrow from the third item DP (comment) in the photo IDS 530 to the pony rides item data in the comment IDS 540. In response to the request, the visitor is presented with a comment which explains that pony rides will be available for people who attend the birthday party. One of ordinary skill in the art will recognize that there are other ways to activate the third item DP (comment) and present the pony rides comment to the visitor. For example, in another embodiment, the second item DP (photo) and the third item DP (comment) might both be included in the calendar IDS 520 meta information. In still another embodiment, an item data pointer in an item data structure's meta information might be activated automatically when the item data structure's item data is requested, without an additional request from a visitor.

In the depicted embodiment, each of the calendar IDS 520, the photo IDS 530 and the comment IDS 540 includes aggregated visitor information about visitors who requested the respective item data. The aggregated visitor information is obtained from the visitor's browser when the visitor accesses the respective item data, as described in detail herein. The aggregated visitor information is updated for each request for the item data and is made available to the owner of the item. One of ordinary skill in the art will recognize that this can occur in a variety of ways.

In FIG. 5, three item data pointers are each designated first item data pointer (cal event) 510. In the depicted embodiment, although not shown, each of these item data pointers is included in a calendar in a respective different user's view. One of the views may be a view of the owner of the calendar event item, and the other two may be views of visitors who copied the birthday party item and placed it in their respective calendars in accordance with the method for copying items as described in detail herein. In the depicted embodiment, if the owner of the birthday party calendar event item changes the time, date or location of the party, by modifying the calendar event item data in the calendar IDS 520, the change would also be reflected in the birthday party calendar event in the respective visitors' calendars. This is because each of the first item data pointers (cal event) 510 points to the same calendar IDS 520.

From the above description, a number of advantages of the present invention are apparent. In accordance with one embodiment of the present invention, an item such as a car photo can easily and quickly be copied and displayed many times by many users throughout the online networking system, utilizing profile data pointers, profile data structures, item data pointers and an item data structure that includes the item data. Aggregated biographical information relating to the copying and displaying operations can quickly, efficiently and cost-effectively be made available. Each user who copied the item can delete it without affecting the owner's or other users' copies. However, if the owner decides to change or delete the item, it is effectively changed or deleted for all other users as well. This allows the owner and the online networking system to maintain control over the content on the system.

As noted above, the present invention allows for a wide variety of items in many different formats to be used in the online networking system. In the illustrated embodiment, an item can be a picture, a photo, an audio file, a video file, an email message, a bulletin, a blog posting, a comment, an RSS feed or a calendar event. In other embodiments, other items might be used. As also noted above, the meta information in an item data structure can include item data pointers to other item data structures. The type of item data in the item data structures to which such item data pointers point is not restricted by item type or format. Thus, a photo might include comments about the photo, a blog posting might include a video clip, an email message might include a calendar event, and so on. The extent to which an item can include a pointer to other items in its meta information is not limited to two layers. In other words, an item can be included in an item included in another item, and so on. Profile data pointers may also be included in meta information. The use of data pointers and data structures in this way allows for great flexibility and ease of use, yet also permits a degree of maintenance and control that is important for safe and secure operation of the system. The collection of biographical information with respect to the behavior of each user throughout the system, and the inclusion of aggregated biographical information in the relevant data structure allows for the reporting of reliable, accurate, safe and highly valuable non-personal information quickly, efficiently and cost-effectively. The system can permit delivery of highly effective personally-targeted ads without disclosure of personally-identifying information.

Particular embodiments of the invention have been illustrated and described above. One of ordinary skill in the art will realize that the invention may take other forms and embodiments within the scope of the appended claims.

While the present invention has been described in connection with specific embodiments, variations of these embodiments will be obvious to those of ordinary skill in the art. Moreover, the functions of transmitting, storing, managing and retrieving digitized data and information may be accomplished in many different ways using a variety of components and configurations, as will be understood by those of skill in the art. Therefore, the spirit and scope of the appended claims should not be limited to the foregoing description. Only those claims specifically reciting “means for” or “step for” should be construed in the manner required under the sixth paragraph of 35 U.S.C. Section 112.

What is claimed is:

1. A method comprising:
a. creating a profile data structure, the profile data structure including:
i. information specific to an owner, wherein the information specific to the owner includes information to present a view responsive to a request, the view including a thumbnail of a representation of the owner and a plurality of thumbnails of representations of a plurality of visitors; and
ii. an owner identifier;
b. creating an item data structure, the item data structure including:
i. item data; and
ii. an item data owner identifier that identifies the owner as an owner of the item data;
c. creating an item data pointer, associated with the profile data structure, that points to the item data structure;
d. receiving a request from a visitor for the item data via the item data pointer; and
e. presenting the item data to the visitor.

2. The method of claim 1, wherein the information specific to the owner further includes biographical information about the owner.

3. The method of claim 1, wherein the information specific to the owner in the profile data structure includes:
a. a plurality of item data pointers, and
b. a plurality of profile data pointers.

4. The method of claim 1, wherein the information specific to the owner further includes information about views presented to the owner from other profile data structures.

5. The method of claim 1, wherein the information specific to the owner further includes aggregated biographical information about visitors who requested the view.

6. The method of claim 1, further comprising receiving a request for the view, and presenting a thumbnail responsive to the request.

7. The method of claim L, wherein the item data represents one of a message, a comment, a bulletin posting and a blog posting.

8. The method of claim 1, wherein the item data represents a calendar event.

9. The method of claim 1, wherein the item data represents an RSS feed.

10. The method of claim 1, wherein the item data represents a photograph and the view includes a thumbnail of the photograph.

11. The method of claim 1, wherein the item data structure further includes information that identifies a type of the item data.

12. The method of claim 1, wherein the item data structure further includes aggregated visitor information, including biographic information about the visitor and a plurality of other visitors who requested the item data.

13. The method of claim 1, wherein the item data pointer identifies a type of the item data.

14. The method of claim 13, wherein the information that identifies the type of the item data identifies the type of the item data as representing one of a blog posting, a calendar event, and an RSS feed.

15. The method of claim 1, wherein the item data pointer comprises an encrypted timestamp.

16. A method comprising:
a. creating a profile data structure including:
i. information specific to an owner, including owner biographical information about the owner, the owner biographical information including the owner's age; and
ii. an owner identifier
b. creating an item data structure including:
i. the item data; and
ii. an item data owner identifier that identifies the owner as an owner of the item data;
c. creating an item data pointer, associated with the profile data structure, that points to the item data structure;
d. receiving a request from a visitor for the item data via the item data pointer;
e. presenting the item data to the visitor; and
f. collecting visitor biographical information about the visitor and storing the visitor biographical information in the item data structure

17. The method of claim 16, further comprising aggregating the visitor biographical information with second visitor biographical information about other visitors who requested the item data and storing the aggregated biographical information in the item data structure.

18. The method of claim 17, further comprising presenting the aggregated biographical information to the owner.

19. The method of claim 16, wherein the visitor biographical information is received from the visitor's web browser.

20. The method of claim 16, wherein the visitor biographical information is received from a cookie.

21. The method of claim 20, wherein the item data is presented to the visitor during a login session; and wherein the cookie was delivered to the visitor in connection with a previous session.

22. The method of claim 16, wherein the information specific to the owner includes:
a. a plurality of item data pointers; and
b. a plurality of profile data pointers.

23. The method of claim 16, wherein the information specific to the owner includes information to present a view responsive to a request, the view comprising a thumbnail of a representation of the owner and a plurality of thumbnails of representations of a plurality of other visitors.

24. The method of claim 23, further comprising receiving a request for the view, and presenting a thumbnail responsive to the request.

25. The method of claim 16, wherein the information specific to the owner includes the visitor biographical information aggregated with additional visitor biographical information about additional visitors who requested the view.

26. The method of claim 16, wherein the information specific to the owner further includes information about views presented to the owner from other profile data structures

27. The method of claim 16, wherein the item data structure further includes a second item data pointer that points to a second item data structure, the second item data structure including:
a. second item data; and
b. a second item data owner identifier that identifies a second owner of the second item data.

28. The method of claim 27, wherein the second item data structure further includes aggregated visitor information, including biographic information about a plurality of visitors who requested the second item data via the second item data pointer.

29. A method comprising:
a. creating a first profile data structure including:
i. information specific to an owner of an item, and
ii. an owner identifier;
b. creating an item data structure including:
i. item data representing the item; and
ii. an item data owner identifier that identifies the owner as the owner of the item.
c. creating a first item data pointer, associated with the first profile data structure, that points to the item data structure;
d. creating a second profile data structure including:
i. information specific to a visitor, wherein the information specific to the visitor includes information to present a view responsive to a request, the view comprising a thumbnail of a representation of the visitor and a plurality of thumbnails of representations of a plurality of other visitors; and
ii. a visitor identifier;
e. receiving a request from the visitor for a copy of the item; and
f. responsive to the request, creating a second item data pointer associated with the second profile data structure that points to the item data structure.

30. The method of claim 29, further comprising collecting biographical information about the visitor responsive to the request and associating the biological information about the visitor with the item data.

31. The method of claim 30, further comprising storing the biographical information about the visitor in the item data structure.

32. The method of claim 29, further comprising receiving a request from a second visitor for the item data via the second pointer, and presenting the item data to the second visitor.

33. The method of claim 32, further comprising collecting biographical information about the second visitor responsive to the second request and associating the biographical information with the item data.

34. The method of claim 33, further comprising storing the biographical information about the second visitor in the item data structure.

35. The method of claim 29, further comprising receiving a plurality of requests for the item data, via the second item data pointer, from a plurality of additional visitors; presenting the item data to each of the additional visitors; collecting biographical information about the additional visitors responsive to the requests; and aggregating the visitor information information.

36. The method of claim 35, further comprising associating the aggregated visitor information with the item data.

37. The method of claim 35, further comprising storing the aggregated visitor information in the item data structure.

38. The method of claim 35, further comprising presenting the aggregated visitor information to the owner.

39. The method of claim 29, further comprising receiving a number of requests for the item data, via the second item data pointer, from a plurality of additional visitors, and storing the number in the item data structure.

40. The method of claim 39, further comprising relating the number to the first visitor profile.

41. The method of claim 29, further comprising creating a thumbnail of the item represented by the item data, and including the thumbnail in the view.

42. The method of claim 41, wherein the thumbnail is optionally sizable by the visitor.

43. The method of claim 41, wherein the location of the thumbnail within the view is optionally determinable by the visitor.

44. The method of claim 41, wherein the item is a video clip, and wherein the thumbnail is a reduced-size screenshot from the video clip.

45. A method comprising:
a. creating a first profile data structure including:
i. information specific to an owner of an item; and
ii. an owner identifier;
b. creating an item data structure, the item data structure including:
i. item data representing the item; and
ii. an item data owner identifier that identifies the owner as the owner of the item;
c. creating a first item data pointer associated with the first profile data structure that points to the item data structure;
d. creating a second profile data structure including:
i. information specific to a visitor, wherein the information specific to the visitor includes information to present a view responsive to a request, the view comprising a thumbnail of a representation of the visitor and a plurality of thumbnails of representations of a plurality of other visitors; and
ii. a visitor identifier;
e. receiving a request from the visitor for a copy of the item; and
f. responsive to the request:
i. creating a second item data pointer;
ii, storing the second item data pointer in a temporary storage area associated with the second profile data structure; and
iii. responsive to a second request from the visitor, including the second item data pointer in the second profile data structure.

46. A method for deleting item data, the method comprising:
a. deleting an item data pointer to an item data structure, said item data pointer associated with a deleter profile data structure, said item data structure including:
i. the item data; and
ii. an owner identifier that identifies an owner of the item data;
b. determining whether the owner identifier identifies the deleter as the owner of the item data; and
c. if the owner identifier identifies the deleter as the owner of the item data, then deleting the item data structure.

47. The method of claim 46, further comprising:
d. receiving a request for the item data via an item data pointer associated with a visitor profile data structure; and
e. if the owner identifier identifies the deleter as the owner of the item data; then the item data is not presented in response to the request.

48. A method comprising:
a. storing a media item as item data;
b. creating an item data structure that includes the item data and item-specific information, wherein the item-specific information includes:
i. an owner identifier that identifies an owner of the item data; and
ii. aggregated visitor information specific to the item data; and
c. receiving visitor requests, from each of a plurality of visitors, for the item data and, for each request, updating the aggregated visitor information with biographical information about the visitor making the request.

49. The method of claim 48, wherein the item data structure consists essentially of the item data and the item-specific information.

50. The method of claim 48, further comprising receiving a number of visitor requests, from a plurality of visitors, and storing the number in the item data structure.

51. The method of claim 48, further comprising creating an item data pointer to the item data structure, wherein the visitor requests are received via the item data pointer.

52. The method of claim 48, further comprising creating a plurality of item data pointers to the item data structure, wherein the visitor requests are received via the plurality of item data pointers.

53. The method of claim 48, wherein the visitors issue the visitor requests from respective browsers, and wherein the biographical information about the visitor making the request is received from the respective browser.

54. The method of claim 48, wherein the biographical information about the visitor making the request is received in a cookie.

55. An item data structure comprising:
a. item data representing an item;
b. an owner identifier that identifies an owner of the item data; and
c. aggregated visitor information about visitors who request the item data.

56. The item data structure of claim 55, further comprising information that identifies an item data type for the item data.

57. The item data structure of claim 55, further comprising a thumbnail of the item.

58. The item data structure of claim 55, further comprising meta information specific to the item data.

59. The item data structure of claim 58, wherein the meta information includes a second item data structure.

60. The item data structure of claim 58, wherein the meta information includes an item data pointer to a second item data structure.

61. The item data structure of claim 58, wherein the meta information includes a profile data pointer to a profile data structure.

62. A profile data structure comprising:
a. information specific to an owner, wherein the information specific to the owner includes information to present a view, the view including a thumbnail of a representation of the owner and a plurality of additional thumbnails of representations of a plurality of visitors;
b. an owner identifier; and
c. aggregated visitor information, including biographic information about a plurality of visitors who requested the view from the owner profile data structure.

63. The profile data structure of claim 62, further comprising behavioral information about the owner, including:
a. information about a plurality of views requested by the owner and presented to the owner from a plurality of other profile data structures; and
b. information about item data requested by the owner and presented to the owner from a plurality of item data structures.

64. The profile data structure of claim 63, wherein the information about the plurality of views includes an index of a page presented to the owner in response to an owner request for a view.

65. The profile data structure of claim 63, wherein the information about the item data includes an index of a page presented to the owner in response to an owner request for item data.

66. A calendar system comprising a plurality of first item data pointers, wherein each first item data pointer points to a respective first item data structure, and wherein the first item data structure includes:
a. item data of a calendar event type;
b. an owner identifier that identifies the owner of the calendar event item data; and
c. meta information specific to the calendar event item data;
wherein each first item data pointer includes information that identifies the type of item data in the first item data structure as a calendar event.

67. The calendar system of claim 66, wherein the first item data structure includes aggregated visitor information about visitors who requested the calendar event item data via the plurality of first item data pointers.

68. The calendar system of claim 66, wherein the meta information specific to the calendar event item data includes a second item data pointer that points to a respective second item data structure that includes item data that is not restricted to the calendar event item type.

69. The calendar system of claim 68, wherein the second item data pointer includes information that identifies the type of item data in the second item data structure.

70. The calendar system of claim 68, wherein the second item data structure includes aggregated visitor information about visitors who requested the item data in the second item data structure via the second item data pointer.

71. The calendar system of claim 68, wherein the second item data structure includes meta information specific to the item data in the second item data structure, and wherein the meta information specific to the item data in the second item data structure includes a third item data pointer that points to a third item data structure that includes item data that is not restricted to the calendar event item type.

72. The calendar system of claim 66, wherein the meta information specific to the calendar event item data includes a second item data pointer that points to a respective second item data structure that includes:
a. item data of a photograph type;
b. an owner identifier that identifies the owner of the photograph item data; and
c. meta information specific to the photograph item data; wherein the meta information specific to the photograph item data includes a third item data pointer that points to a third item data structure that includes item data that represents a comment.

73. A method for copying calendar events, the method comprising:
a. creating an owner profile data structure containing information specific to an owner;
b. creating an item data structure including:
i. item data that represents a calendar event item; and
ii. an owner identifier that identifies the owner as the owner of the calendar event item;
c. creating a first item data pointer associated with the owner profile data structure, wherein the first item data pointer points to the item data structure;
d. creating a visitor profile data structure containing information specific to a visitor;
e. receiving a request from the visitor for a copy of the calendar event item; and
f. responsive to the request, creating a second item data pointer associated with the visitor profile data structure, wherein the second item data pointer points to the item data structure.

74. The method of claim 73, further comprising
a. modifying the item data responsive to a request for modification by the owner; and
b. presenting the modified item data to the visitor responsive to a request for the item data by the visitor.
